(19) United States
(12) Patent Application Publication
(10) Pub. No.: US 2026/0097651 A1
(43) Pub. Date: Apr. 9, 2026

(54) CIVIL ENGINEERING MACHINE AND METHOD FOR OPERATING A CIVIL ENGINEERING MACHINE

(71) Applicant: BAUER Maschinen GmbH, Schrobenhausen (DE)

(72) Inventors: Peter BRÜDERLE, Karlskorn (DE); Andreas SCHOBER, Wertingen (DE)

(73) Assignee: BAUER Maschinen GmbH, Schrobenhausen (DE)

(21) Appl. No.: 19/114,109

(22) PCT Filed: Sep. 27, 2023
(86) PCT No.: PCT/EP2023/076670

§ 371 Date: Mar. 21, 2025

(30) Foreign Application Priority Data
Oct. 6, 2022 (EP) 22199996.4

(51) Int. Cl. B60K 35/28; B60K 35/22; E02D 13/00; E21B 7/02; G06F 3/14; G06T 3/40

(52) U.S. Cl. CPC B60K 35/28; B60K 35/22; E02D 13/00; E21B 7/02; G06F 3/14; G06T 3/40; B60K 2360/171

(57) ABSTRACT

The invention relates to a civil engineering machine, in particular a drilling rig, having a mobile carrier device, a mast or jib arm which is arranged on the carrier device, a civil engineering tool which is arranged adjustably on the mast or the jib arm in order to carry out a civil engineering operation, at least one display device, in particular a monitor, and a control unit which is configured to control components of the civil engineering machine and to detect operating states and, depending on detected operating data, to generate an at least schematic representation of at least one part of the civil engineering machine and to display it by means of the at least one display device, wherein a change in position of the civil engineering tool and/or at least one component of the civil engineering machine is displayed in the at least schematic representation of the one display device. According to the invention it is provided that the control unit is configured to automatically change a display scale and/or a type of representation of the at least schematic representation of the display device in the event of certain changes in position of the civil engineering tool and/or of at least one component of the civil engineering machine.

The invention relates to a civil engineering machine, in particular a drilling rig, having a mobile carrier device, a mast or jib arm which is arranged on the carrier device, a civil engineering tool which is arranged adjustably on the mast or the boom arm in order to carry out a civil engineering operation, at least one display device, in particular a monitor, and a control unit which is configured to control components of the civil engineering machine and to detect operating states and, depending on collected operating data, to generate an at least schematic representation of at least one part of the civil engineering machine and to display it by means of the at least one display device, wherein a change in position of the civil engineering tool and/or at least one component of the civil engineering machine is displayed in the at least schematic representation of the one display device, according to the preamble of claim 1.

The invention further relates to a method for operating such a civil engineering machine according to the preamble of claim 14.

The civil engineering machine can be, for example, a trench cutter, a pile driver, a cable-operated excavator, a grab excavator, but also a mobile crane or a mobile jib crane.

Civil engineering machines, in particular for creating foundations in the ground, have been known for a long time. A foundation element can be formed, for example, by creating a hole in the ground, such as a drilled hole or a milled slot, wherein the hole is then filled with a curable medium, in particular cement, to form a foundation pile or a diaphragm wall segment, if necessary with additional reinforcement. A foundation element can also be created by driving or vibrating in, for example a foundation pile or a panel. A foundation element is not limited here to a load pickup or a load-bearing function, but can alternatively or additionally take on a sealing function and/or other tasks, as is known, for example, in the case of excavation pit enclosures with sealing walls from specialised civil engineering.

Nowadays, well-known civil engineering machines are equipped with electronic control units that can facilitate the operation of the civil engineering machine for a machine operator or even take over the operation partially or fully automatically. Various operating data can be collected via sensors and fed to the control unit. Control commands can be issued to corresponding actuators, in particular drives and actuating cylinders, via corresponding data lines.

Such civil engineering machines are known, for example, from EP 3299523 A1 and EP 3296467 A1.

Display devices in civil engineering machines are used to display operating data collected by the control unit from internal and/or external sensors to the machine operator so that he can control the civil engineering machine respectively effectively and safely. The data can be, for example, the current depth of the civil engineering tool, the torque of a winch or also the temperature of the oil in an oil circuit.

Depending on the machine equipment and/or a work process to be carried out, a large amount of data must be displayed and visualised to a machine operator in order to be able to create a foundation element reliably and efficiently. The existing problem is that the machine operator is distracted by a flood of data from those data that may be essential for an upcoming method step.

The object underlying the invention is to specify a civil engineering machine and a method for operating a civil engineering machine which enable particularly efficient utilisation of a civil engineering machine by the machine operator.

This object is achieved, on the one hand, by a civil engineering machine having the features of claim 1 and, on the other hand, by a method having the features of claim 14.

Preferred embodiments of the invention are given in the dependent claims and in the Figures and their description.

The civil engineering machine according to the invention is characterised in that the control unit is configured to automatically change a display scale and/or a type of representation of the at least schematic representation of the display device in the event of certain changes in position of the civil engineering tool and/or of at least one component of the civil engineering machine.

A basic idea of the invention resides in that the control unit is configured to automatically change the display scale and/or a type of representation of the at least schematic representation of the display device in the event of certain changes in position of the civil engineering tool and/or of at least one component of the civil engineering machine. For example, at the start of the actual ground working operation, the ground working tool can be displayed enlarged in the at least schematic representation in this way. This automatic change in the display makes it clear to the machine operator that the ground is about to be worked and that his attention is focused on this. This promotes an efficient work process and counteracts operating errors.

The display can take place in a very schematic way, wherein the civil engineering machine and/or the ground working tool are shown in a highly simplified form. This reduces the necessary computing power, memory space and programming effort. However, a realistic display can also take place in parts or as a whole if the corresponding computing power and memory space are available.

A preferred embodiment of the invention resides in that the type of representation comprises a display perspective and/or a display detail and/or partial displays and/or a partially transparent display. The display perspective can in particular be a side view, a plan view, i.e. a display from a bird's eye view, or a perspective view.

For example, a side view of the tool with the display of a bottom of a borehole can thus take place during the actual ground working operation, while a perspective display or a plan view from above is provided when the tool is emptied at the ground surface or when the civil engineering machine is being moved, for example. Depending on the operating status or the respective working step, an overall display of the civil engineering machine or only a display detail or a partial display and/or a partially transparent display can be useful, in particular if, for example, only the tool is shown during the actual ground working operation.

A partially transparent display can be used, for example, to clearly illustrate the filling of a vitreously shown drilling bucket, while the remaining machine components are shown normally.

According to a further configuration, a particularly simple embodiment of the invention is achieved in that the control unit is configured that a change in the display scale and/or the type of representation takes place by switching without a transition. Simple switching leads to a clear structure and does not require excessive computing power.

A further embodiment variant of the invention resides in that the control unit is configured that a change in the display scale and/or the type of representation takes place dynamically with a smooth transition. In particular, a transition from a partial display to an overall display can take place with a smooth zoom image progression. A display from a side view to a perspective view can also take place with a smooth transition, which can lead to a particularly good visualisation of certain working steps. A smooth transition, which can be similar to a camera pan, can also visualise a relevant change in the method sequence and the upcoming of a new working step particularly well for a machine operator.

According to a preferred embodiment of the invention, a particularly good increase in awareness of the upcoming method sequence and/or a change in the method sequence for the machine operator can be achieved in that the control unit is configured to display at least a part of the civil engineering machine initially in a first display scale and/or a first display perspective and/or a first display detail and/or a first partial display and/or a full display or transparency display and to switch or change over to a second display scale and/or a second display perspective and/or a second display detail and/or a second partial display and/or a transparency display or full display in accordance with a predetermined program control when a specific position or state of the civil engineering tool and/or at least one component of the civil engineering machine is reached. For this purpose, corresponding sensors can be arranged on the civil engineering machine, with which the position or state of the civil engineering tool or one of the components of the civil engineering machine can be detected. The sensors are connected here to the control unit. A (partial) transparency display can be used in particular to visualise the filling level of a civil engineering tool.

According to a betterment of the invention, it is particularly advantageous that the control unit is configured to dynamically change the display detail in such a way that the civil engineering tool is always displayed in the centre, in particular when it reaches ground to be worked on. In particular during the actual working operation with the civil engineering tool, this can be displayed in a centred manner. For the purposes of the invention, ‘centred’ is not to be understood as a strict centring on a screen, but rather a display in a central region of the screen, at least not at the edge of the screen. In addition to a centred display of the civil engineering tool, other components of the civil engineering machine can also be displayed in a centred manner, depending on the method sequence and individual method steps.

According to a betterment of the invention, a particularly good visualisation can be achieved by the control unit being configured that, from a certain working depth, a transition is made from an overall display of the civil engineering machine to at least one partial display, in which parts of the civil engineering machine are omitted, in particular parts of a drill pipe and/or guide rod or a support cable. In this way, attention can be focused on special components that are of key importance for a working step and require special attention from the machine operator. Insignificant components do not need to be shown. Preferably, the display scale can also be changed, in particular enlarged, during the transition from an overall display to a partial display.

According to a betterment of the invention, it is preferable that the control unit is configured in such a way that the civil engineering tool is displayed on an enlarged display scale when it penetrates the ground and/or reaches a base of the ground to be worked or shortly before the base is reached. In particular, the interaction of the civil engineering tool with the ground to be worked, such as a filling level of a civil engineering tool, is of decisive importance for the efficiency of the method sequence and ground working. This is further emphasised by this type of display and the machine operator's attention is drawn to it.

According to one embodiment variant of the invention, a particularly good display can be achieved in that the control unit is configured in such a way that the carrier device is displayed on a reduced display scale relative to the civil engineering tool and/or other components of the civil engineering machine. In this way, an overall display of the civil engineering machine can be carried out, wherein the civil engineering tool and/or other components of the civil engineering machine are displayed with different display scales and, if necessary, with different fidelity, depending on their significance for the respective method step.

According to a betterment of the invention, it can be advantageous, in particular after completion of the actual ground working operation or a ground working step, for the control unit to be configured in such a way that the display scale is reduced when the civil engineering tool is pulled out of the ground. The display scale can be reduced in particular in relation to the civil engineering tool, wherein preferably the same display scale is achieved for the civil engineering machine as a whole. This allows the machine operator to develop a better feel for the overall depth of a borehole, for example.

According to a further preferred embodiment variant of the invention, it is provided that the control unit is configured that a change in the display perspective from a side view to a plan view of the civil engineering machine and/or vice versa is effected immediately before or when a superstructure, which is mounted rotatably about a vertical pivot axis on an undercarriage of the carrier device, is pivoted. As a result, the machine operator's attention can now be focused on the fact that the superstructure is about to be pivoted. A display mode can be triggered by a control actuation of the machine operator, by a program control itself or by sensor data. The civil engineering machine can also be equipped here with one or more cameras and other sensors, such as radar or lidar/ladar sensors, in order to detect a surrounding of the civil engineering machine, in particular possible obstacles. The surroundings detected in this way and possible obstacles can be taken into account in the plan view display of the civil engineering machine, so that safe operation of the civil engineering machine is supported for the machine operator.

The civil engineering machine is basically configured for carrying out a civil engineering operation, in particular for specialised civil engineering, i.e. for foundation work. According to one embodiment of the invention, it is particularly advantageous that the civil engineering machine is configured as a drilling rig, a trench cutter, a gripping device, a pile driver, a vibrator, a grab excavator or a cable-operated excavator. A cable-operated excavator can generally be understood as a mobile crane with a pivotable jib arm, wherein a gripping device does not necessarily have to be arranged on a support cable of the jib arm. Rather, a cable-operated excavator or mobile crane can also be used for soil compaction using a drop weight, for example.

According to a betterment of the invention, it is advantageous that a switching device is arranged, with which an automatic change of the display scale and/or the type of representation can be activated and deactivated by the control unit. The switching device can be operated by the machine operator so that this operator can activate or deactivate the desired display mode.

The method according to the invention is characterised in that a display scale and/or a type of representation of the at least schematic representation of the display device is automatically changed by the control unit in the event of certain changes in position of the civil engineering tool and/or of at least one component of the civil engineering machine.

The method according to the invention can be carried out, in particular with the previously described civil engineering machine according to the invention and one of the described betterments thereof. The advantages described above can be achieved here.

The invention is explained further below with reference to preferred exemplary embodiments, which are shown schematically in the drawings. The drawings show:

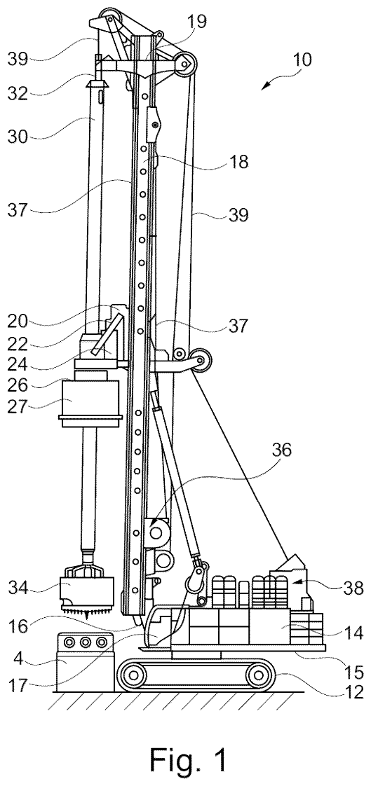

FIG. 1 a schematic side view of a civil engineering machine according to the invention; and

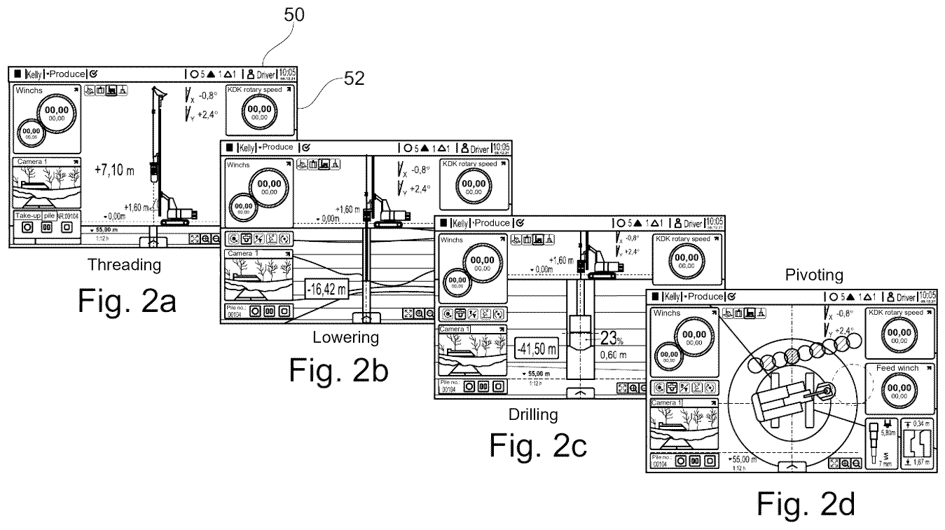

FIGS. 2a to 2d a sequence of possible displays on a monitor.

A civil engineering machine 10 according to the invention, which is configured by way of example as a drilling rig according to FIG. 1, has an undercarriage 12, preferably configured as a crawler chassis, and a superstructure 14 rotatably mounted thereon. The undercarriage 12 and the superstructure 14 form a carrier device 15. The drive assemblies and an operator's stand 17 for a machine operator of the civil engineering machine 10 can be arranged on the superstructure 14 in a known manner. A control unit and a display device, in particular at least one monitor, can be arranged in the operator's stand 17.

A substantially vertical mast 18 with an upper mast head 19 can be adjustably attached to a front side of the superstructure 14 via articulation kinematics 16 with neck cylinders. A carriage 20 can be displaceably guided along a front side of the mast 18. A first drilling drive 22 can be provided on the carriage 20 and can have a hydraulic motor 24. Furthermore, a second drive 26 with a sleeve-shaped rotary connection 27 can be provided on the carriage 20 to establish a non-rotatable connection to a support tube 4. The second drive 26 can, for example, consist substantially of a gear connection to the first drill drive 22 with the hydraulic motor 24 in order to apply a torque to the rotary connection 27 and thus to the support tube 4.

The approximately sleeve-shaped first drill drive 22 can, for example, be penetrated by a drill pipe 30, which can be configured as a Kelly rod with outer driver strips. In this case, the drill pipe 30 can have an upper suspension 32, with which the drill pipe 30 is connected to a main cable 39. The main cable 39 can be guided to a main winch 38 on the upper side of the superstructure 14 via guide pulleys on the mast head 19. By actuating the main winch 38, the drill pipe 30 can be moved vertically.

The carriage 20 can be connected to a feed cable 37, which is guided above and below the carriage 20 along the mast 18 and can be actuated by a feed winch 36. The feed winch 36 can move the carriage 20 upwards or downwards along a guide of the mast 18.

A drilling tool is attached to an underside of the drill pipe 30 as a civil engineering tool 34 for removing soil material. In the exemplary embodiment shown in FIG. 1, the civil engineering tool 34 is configured as a drilling bucket. The diameter of the drilling tool is here configured so that it can be inserted into the inner cavity of the support tube 4.

The civil engineering machine 10 can be used to create a cased borehole in the ground 1. To form a foundation element in the ground 1, a curable material can be introduced into the borehole, which then cures to form the foundation element. The support tube 4 can remain in the borehole as part of the foundation element or preferably can be pulled out of the ground 1 before a curing.

To illustrate the invention, FIGS. 2a to 2d show a schematic sequence of representations on a monitor 52 of a display device 50, as can be used, in particular in the civil engineering machine 10 according to FIG. 1.

The screen display according to FIG. 2a on a monitor 52, preferably in the operator's stand 17 of the civil engineering machine 10 according to FIG. 1, schematically shows the civil engineering machine 10 in side view in a central region. In this operating state, the civil engineering tool 34 is located above a support tube 4 that has already been inserted into the ground 1, wherein a drilling bucket is to be threaded into the support tube 4 as an exemplary civil engineering tool 34. In this illustration according to FIG. 2a, the civil engineering machine 10 is shown schematically and in a highly simplified manner in a side view with a uniform scale from the carrier device 15 up to the upper end of the mast. In addition, at least part of the support tube 4 is shown in the ground 1. In side regions of this schematic representation of the civil engineering machine 10, further key information and operating parameters and also a camera image can be displayed, which are crucial overall for the threading operation.

After threading the civil engineering tool 34 into the support tube 4, an image corresponding to FIG. 2b is displayed on the monitor 52. In this image, a substantial part of the borehole with the support tube 4 in the ground 1 is shown, while an upper end region of the mast 18 of the civil engineering machine 10 is no longer shown. In the image according to FIG. 2b, the civil engineering tool 34 can be seen in a centre region of the monitor 52 as an exemplary display device 50. Besides the civil engineering tool 34, a depth indication can be carried out in a separate field to the civil engineering tool 34, wherein in the exemplary embodiment according to FIGS. 2b, 16.42 metres below the ground surface is indicated as the current depth. In this process of lowering according to FIG. 2b, the civil engineering tool 34 can be depicted with the same display scale or a slightly enlarged display scale compared to FIG. 2a.

Immediately before a base is reached in the borehole in the ground 1 by the civil engineering tool 34, the display form can be changed according to FIG. 2c. In this case, the civil engineering tool 34 is shown on a larger scale than the rest of the civil engineering machine 10, wherein the overall display is not uniform or true to scale. The current depth of the tool, the theoretical depth or target depth and, in this example, a filling level of the drilling bucket as a civil engineering tool 34 can be displayed directly next to the civil engineering tool 34, which is shown substantially in the centre, as key data directly to the civil engineering tool 34.

After the drilling step and after pulling the filled civil engineering tool 34 out of the borehole and the support tube 4 in the ground 1, the superstructure 14 of the civil engineering machine 10 must be pivoted to an emptying position. A perspective according to FIG. 2d can be changed here from the side view shown in FIGS. 2a to 2c to a plan view as shown in FIG. 2d. Once again, the display scale of the civil engineering machine 10 can be changed here. The machined borehole or the already machined boreholes can also be shown in this Figure.

1. A civil engineering machine, in particular drilling rig, having
a mobile carrier device
a mast or jib arm which is arranged on the carrier device,
a civil engineering tool which is arranged adjustably on the mast or the jib arm in order to carry out a civil engineering operation,
at least one display device, in particular a monitor, and
a control unit which is configured to control components of the civil engineering machine and to detect operating states and, depending on detected operating data, to generate an at least schematic representation of at least one part of the civil engineering machine and to display it by means of the at least one display device wherein a change in position of the civil engineering tool and/or at least one component of the civil engineering machine is displayed in the at least schematic representation of the display device,
wherein
the control unit is configured to automatically change a display scale and/or a type of representation of the at least schematic representation of the display device in the event of certain changes in position of the civil engineering tool and/or of at least one component of the civil engineering machine.

2. The civil engineering machine according to claim 1, wherein
the type of representation comprises a display perspective and/or a display detail and/or partial displays and/or a partially transparent display.

3. The civil engineering machine according to claim 1, wherein
the control unit is configured that a change in the display scale and/or the type of representation takes place by switching without a transition.

4. The civil engineering machine according to claim 1,
wherein
the control unit is configured that a change in the display scale and/or the type of representation takes place dynamically with a smooth transition.

5. The civil engineering machine according to claim 1,
wherein
the control unit is configured to display at least a part of the civil engineering machine initially in a first display scale and/or a first display perspective and/or a first display detail and/or a first partial display and to switch or change over to a second display scale and/or a second display perspective and/or a second display detail and/or a second partial display in accordance with a predetermined program control when a specific position or state of the civil engineering tool-(34) and/or at least one component of the civil engineering machine (10) is reached.

6. The civil engineering machine according to claim 1,
wherein
the control unit is configured to dynamically change the display detail in such a way that the civil engineering tool is always displayed in the centre, in particular when the civil engineering tool reaches ground to be worked on.

7. The civil engineering machine according to claim 1,
wherein
the control unit is configured that, from a certain working depth, a transition is made from an overall display of the civil engineering machine to at least one partial display, in which parts of the civil engineering machine are omitted, in particular parts of a drill pipe and/or guide rod or a support cable.

8. The civil engineering machine according to claim 1,
wherein
the control unit is configured that the civil engineering tool is displayed on an enlarged display scale when the civil engineering tool penetrates the ground and/or reaches a base of a hole in the ground to be worked or shortly before the base is reached.

9. The civil engineering machine according to claim 1,
wherein
the control unit is configured that the base carrier is displayed on a reduced display scale relative to the civil engineering tool and/or other components of the civil engineering machine.

10. The civil engineering machine according to claim 1,
wherein
the control unit is configured that the display scale is reduced when the civil engineering tool is pulled out of the ground.

11. The civil engineering machine according to claim 1,
wherein
the control unit is configured that a change in the display perspective from a side view to a plan view of the civil engineering machine and/or vice versa is effected immediately before or when a superstructure, which is mounted rotatably about a vertical pivot axis on an undercarriage of the carrier device, is pivoted.

12. The civil engineering machine according to claim 1,
wherein
the civil engineering machine is configured as a drilling rig, a trench cutter, a gripping device, a pile driver, a vibrator, a grab excavator or a cable excavator.

13. The civil engineering machine according to claim 1,
wherein
a switching device is arranged, with which an automatic change of the display scale and/or the type of representation can be activated and deactivated by the control unit.

14. A method for operating a civil engineering machine, in particular according to claim 1, having
a mobile carrier device,
a mast or jib arm which is arranged on the carrier device,
a civil engineering tool which is arranged adjustably on the mast or the jib arm in order to carry out a civil engineering operation,
at least one display device, in particular a monitor, and
a control unit,
wherein components of the civil engineering machine are controlled and operating states are identified by the control unit, and
wherein, depending on detected operating states, a at least schematic representation of at least one part of the civil engineering machine is generated by the control unit and is displayed on the at least one display device, wherein a change in position of the civil engineering tool and/or of at least one component of the civil engineering machine is displayed in the at least schematic representation of the display device,
wherein
a display scale and/or a type of representation of the at least schematic representation of the display device is changed automatically by the control unit immediately before or in the event of certain changes in position of the civil engineering tool and/or of at least one component of the civil engineering machine.
